(19) United States
(12) Patent Application Publication
(10) Pub. No.: US 2013/0114165 A1
(43) Pub. Date: May 9, 2013

(54) FePt-C BASED MAGNETIC RECORDING MEDIA WITH ONION-LIKE CARBON PROTECTION LAYER

(71) Applicants: Oleksandr Mosendz, San Jose, CA (US); Simone Pisana, San Jose, CA (US); Franck D. R. dit Rose, San Jose, CA (US); Dieter K. Weller, San Jose, CA (US)

(72) Inventors: Oleksandr Mosendz, San Jose, CA (US); Simone Pisana, San Jose, CA (US); Franck D. R. dit Rose, San Jose, CA (US); Dieter K. Weller, San Jose, CA (US)

(73) Assignee: Hitachi Global Storage Technologies Netherlands B.V., Amsterdam, NL (unknown)

(21) Appl. No.: 13/290,940

(22) Filed: Nov. 7, 2011

(51) Int. Cl. G11B 5/48; G11B 5/64

(52) U.S. Cl. 360/244; 428/826; G9B/5.147; G9B/5.236

(57) ABSTRACT

A magnetic media for magnetic data recording having a plurality of magnetic grains protected by thin layers of graphitic carbon. The layers of graphitic carbon are formed in a manner similar to onion skins on an onion and can be constructed as single monatomic layers of carbon. The thin layers of graphitic carbon can be formed as layers of graphene or as fullerenes that either cover or partially encapsulate the magnetic gains. The layers of graphitic carbon provide excellent protection against corrosion and wear and greatly reduce magnetic spacing for improved magnetic performance.

### FIELD OF THE INVENTION

The present invention relates to magnetic data recording and more particularly to magnetic media having layers of graphitic carbon as protective layers for improved protection from physical damage and corrosion.

### BACKGROUND OF THE INVENTION

A key component of a computer is an assembly that is referred to as a magnetic disk drive. The magnetic disk drive includes a rotating magnetic disk, write and read heads that are suspended by a suspension arm adjacent to a surface of the rotating magnetic disk and an actuator that swings the suspension arm to place the read and write heads over selected circular tracks on the rotating disk. The read and write heads are directly located on a slider that has an air bearing surface (ABS). When the slider rides on the air bearing, the write and read heads are employed for writing magnetic impressions to and reading magnetic impressions from the rotating disk. The read and write heads are connected to processing circuitry that operates according to a computer program to implement the writing and reading functions.

One parameter that greatly affects the performance of the magnetic recording system is the magnetic spacing between the read and write heads and the magnetic recording layer of the media. However, in order to ensure that the magnetic recording system has a long, reliable life, the magnetic recording layer must be protected from corrosion and from damage, such as from contact with the magnetic head or slider. In order to prevent such corrosion or damage, magnetic heads have been provided with protective coating layers. While these layers can provide some protection from damage and corrosion, their thickness increases the magnetic spacing, which decreases performance. In addition, these layers have been constructed of materials that change their state at high temperatures and can thereby become compromised. Therefore, there remains a need for a magnetic medium that can provide strong protection of the recording layer, even with high temperature exposure, that can also minimize the magnetic spacing.

### SUMMARY OF THE INVENTION

The present invention provides a magnetic media for magnetic data recording that includes a plurality of magnetic grains, and a plurality of layers of graphitic carbon formed on each of the plurality of magnetic grains.

The layers of graphitic carbon can be layers of graphene, and can be formed as fullerenes that cover or partially encase the individual magnetic grains. The grains can be individually encased in layers of graphitic carbon, or alternatively several grains can be encased in a single set of graphitic carbon layers. The individual pains can be separated from one another only by the layers of graphitic carbon or can be separated from one another by non-magnetic segregants.

The layers of graphitic carbon can be the only protective layers for the magnetic grains, or alternatively one or two additional protective layers can be coated over the layers of graphitic carbon. However, if such additional protective layers are provided, the protection provided by the graphitic carbon allows the thickness of protective layers to be greatly reduced.

The graphitic layers can be formed over the individual magnetic grains in a manner that is analogous to the skins of an onion. The presence of these graphitic layers greatly improves the protection against corrosion and against physical wear, and also advantageously provides reduced magnetic spacing between the magnetic grains and the magnetic head of the disk drive system. This provides significantly enhanced magnetic performance and reliability.

These and other features and advantages of the invention will be apparent upon reading of the following detailed description of preferred embodiments taken in conjunction with the Figures in which like reference numerals indicate like elements throughout.

### BRIEF DESCRIPTION OF THE DRAWINGS

For a fuller understanding of the nature and advantages of this invention, as well as the preferred mode of use, reference should be made to the following detailed description read in conjunction with the accompanying drawings which are not to scale.

FIG. 1 is a schematic illustration of a disk drive system in which the invention might be embodied;

FIG. 2 is an enlarged, cross sectional view of a portion of a magnetic media according to an embodiment of the invention;

FIG. 3 is a view similar to that of FIG. 2 of a magnetic media according to an alternate embodiment of the invention;

FIG. 4 is a view similar to that of FIG. 2 of a magnetic media according to an alternate embodiment of the invention;

FIG. 5 is a view similar to that of FIG. 2 of a magnetic media according to an alternate embodiment of the invention;

FIG. 6 is a view similar to that of FIG. 2 of a magnetic media according to an alternate embodiment of the invention;

FIG. 7 is a view similar to that of FIG. 2 of a magnetic media according to an alternate embodiment of the invention; FIG. 8 is a view similar to that of FIG. 2 of a magnetic media according to an alternate embodiment of the invention;

FIG. 9 is a view similar to that of FIG. 2 of a magnetic media according to an alternate embodiment of the invention;

FIG. 10 is a view similar to that of FIG. 2 of a magnetic media according to an alternate embodiment of the invention;

FIG. 11 is a graph of X photoelectron spectroscopy of a media having graphitic layers versus a media having no such graphitic layers; and

FIG. 12 is graph of lube thickness and bonding fraction over time for a media having graphitic layers and media having no such graphitic layers.

### DETAILED DESCRIPTION OF THE PREFERRED EMBODIMENTS

The following description is of the best embodiments presently contemplated for carrying out this invention. This description is made for the purpose of illustrating the general principles of this invention and is not meant to limit the inventive concepts claimed herein.

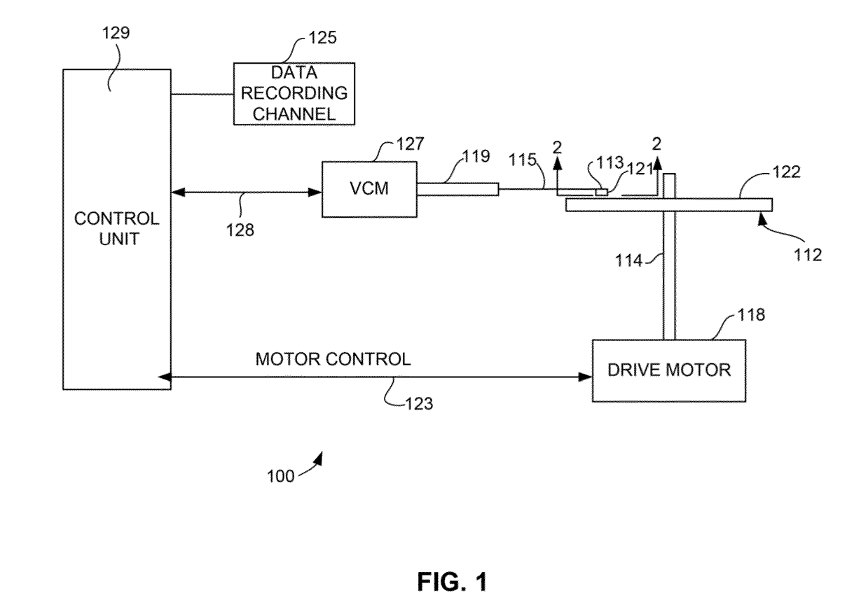

Referring now to FIG. 1, there is shown a disk drive 100 embodying this invention. As shown in FIG. 1, at least one rotatable magnetic disk 112 is supported on a spindle 114 and rotated by a disk drive motor 118. The magnetic recording on each disk is in the form of annular patterns of concentric data tracks (not shown) on the magnetic disk 112.

At least one slider 113 is positioned near the magnetic disk 112, each slider 113 supporting one or more magnetic head assemblies 121. As the magnetic disk rotates, slider 113 moves radially in and out over the disk surface 122 so that the magnetic head assembly 121 can access different tracks of the magnetic disk where desired data are written. Each slider 113 is attached to an actuator arm 119 by way of a suspension 115. The suspension 115 provides a slight spring force which biases slider 113 against the disk surface 122. Each actuator arm 119 is attached to an actuator means 127. The actuator means 127 as shown in FIG. 1 may be a voice coil motor (VCM). The VCM comprises a coil movable within a fixed magnetic field, the direction and speed of the coil movements being controlled by the motor current signals supplied by controller 129.

During operation of the disk storage system, the rotation of the magnetic disk 112 generates an air bearing between the slider 113 and the disk surface 122 which exerts an upward force or lift on the slider. The air bearing thus counter-balances the slight spring force of suspension 115 and supports slider 113 off and slightly above the disk surface by a small, substantially constant spacing during normal operation.

The various components of the disk storage system are controlled in operation by control signals generated by control unit 129, such as access control signals and internal clock signals. Typically, the control unit 129 comprises logic control circuits, storage means and a microprocessor. The control unit 129 generates control signals to control various system operations such as drive motor control signals on line 123 and head position and seek control signals on line 128. The control signals on line 128 provide the desired current profiles to optimally move and position slider 113 to the desired data track on disk 112. Write and read signals are communicated to and from write and read heads 121 by way of recording channel 125.

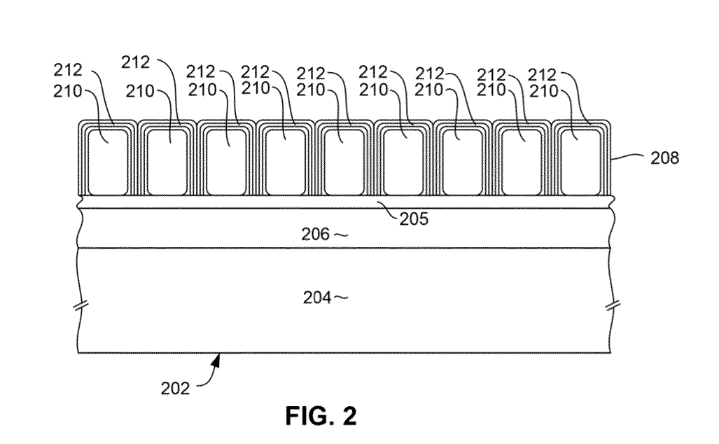

FIG. 2 is an enlarged, cross sectional view of a magnetic media 202 according to an embodiment of the invention. The media includes a substrate 204. The substrate can be formed from a glass or Si disk and can include heat sink layers (not shown). A texturing layer 206 can be formed over the substrate 204. The texturing layer 206 can be a multi-layer such as NiTa/Cr/MgO, NiTa/MgO, although different materials such as Pt, TiN, or TiC, RuAI could be also used.

A magnetic write layer 208 formed over the texturing layer 206. The write layer 208 includes individual grains 210 of a magnetic material having a high coercivity and having a magnetic anisotropy such that they can be magnetized in a direction that is generally perpendicular to the plane of the layers 204, 206, 208 and can remain magnetized in this direction over time without becoming de-magnetized even at elevated temperatures. To this end, the individual grains 210 can be constructed of a material such as FePt-X, where X is Ag, SiOₓ, O, N Au, Cu or Pd. Between the texturing layer 206 and the grains 210 of the write layer 208, there can be a thin FePt seed layer 205 that helps the FePt-X grains to segregate with correct crystallographic orientations.

The magnetic grains 210 are covered and protected by very thin layers of graphitic carbon 212. Carbon can take different forms, such as graphite, graphene (which is a single monatomic layer of graphite), nanotube (a sheet of graphene wrapped into a cylindrical shape), and fullerenes (a sheet of graphene wrapped into a closed shape such as a ball). Fullerenes can be multi-layered, having a form that resembles the skins of an onion formed as several concentric spherical shells. Nanotubes and fullerenes can encapsulate nanomaterials, such as a fullerene cage encasing a nano-crystal inside it (like peas in a pod). Graphene, nanotubes, and fullerenes can be produced by a catalytic or other type of physic-chemical processes at the surface of metallic nanomaterials (for example, fullerenes can be synthesized with nano-crystals inside it, or can grow around or on top of a metallic seed).

The graphitic layers 212 are fullerenes that are formed as onion-like skins that provide excellent wear and corrosion resistance for protecting the magnetic grains 210. Furthermore, as will be shown, the graphitic layers 212 are very compatible with lubricants presently used on magnetic media in magnetic data recording systems, as will be discussed in greater detail herein below.

Growth of corrosion products and high roughness are typical problems encountered on the surfaces of magnetic media in hard disk drives. Protection against oxidation as well as achieving and maintaining a planar surface on a magnetic media are currently achieved by capping the media with a thin (typically less than 35 Angstrom) film of diamond like carbon (DLC), which has been referred to as a carbon overcoat. A drawback of this solution is that the carbon overcoat increases the magnetic spacing between the magnetic sensor in the head and the magnetic recording layer of the magnetic media, causing loss of performance (especially at lower writing fields and read-back signal). Moreover, the magnetic recording layer of the magnetic media and the carbon overcoat are usually deposited on the disk one after the other with different thin film growth techniques. For example, the magnetic layers are first grown as multi-layers by reactive magnetron sputtering, and then the carbon overcoat is deposited by ion beam deposition. This requires moving the disk from one deposition tool to another which requires addition time and manufacturing cost. In fact, media and carbon overcoat deposition require several separate deposition stations, resulting in lower disk production throughput.

The present invention overcomes all of these limitations and challenges. The present invention takes advantage of the presence of carbon atom segregants and high temperature during deposition of FePt—C based Thermally Assisted Recording (TAR) media to form a carbon overcoat. At high temperature, carbon segregants form onion-like graphitic structures 212 as described above with reference to FIG. 2, which encapsulate the magnetic grains 210 and thereby act as a protective overcoat. FePt—C based TAR media with onion-like graphitic overcoat 212 can be advantageously fabricated in one single step, or possibly with several additional steps.

The magnetic grains 210 and graphitic protective layers 212 can be formed in a single step process, or possibly in a multi-step process using highly compatible or identical materials and deposition methods. The onion-like carbon protection overcoat provides protection against corrosion. FeOx formation on the FePt based magnetic grains 210 can cause disk drive failures such as head crashes and irreversible disk damage. A stable anti-corrosion layer of onion-like carbon layers 212 helps to prevent the growth of iron oxide FeOx on the disk surface.

The onion-like carbon protection overcoat 212 also provides surface passivation. The media surface is rendered chemically stable (lower chemical reactivity toward gas and contaminants) by creating a stable graphitic protecting layer at the air-surface interface. This layer can still accommodate the adsorption of the lubrication layer, however. The onion-like protective layer also provides thermal stability. During thermally assisted recording, heat pulses with peak temperatures of 500-600 degrees C. or more (depending on the Curie temperature of the media and on the recording physics) are applied for periods of time of the order of nanoseconds, as determined by the down-track bit length and linear speed of rotation of the disk. Although the duration of the temperature transient is extremely short and each bit may be exposed to these transients for a total of a few seconds when counted through the expected lifetime of the disk drive device, the exposure to high temperature may degrade the carbon overcoat and increase the likelihood of premature drive failure. A further advantage of the proposed graphitic onion-like overcoat is given by the microstructure of the carbon itself, which is unlike typical diamond-like-carbon or amorphous carbon variants currently used in products. Graphite is the thermodynamic ground state for all carbon allotropes. This means that over the course of time, particularly when the material is exposed to increased temperatures, the microstructure of graphitic carbon will not change, contrary to amorphous diamond like carbons that would undergo graphitization, which is the conversion of their sp3 bonded carbon into sp2 bonded carbon. Experiments have shown that temperature treatments above 200-300 degrees C. can change diamond-like-carbon to graphitic carbon [Robertson, Mat Sci Eng R 37, 129-181 (2002)]. If the material is graphitic to begin with, then heat transients will have little to no effect on the microstructure of the graphitic carbon. Therefore, the proposed onion-like protection layer is more robust than typical carbon overcoats for thermally assisted recording and, therefore, helps to prevent premature disk drive failure.

FIG. 2, shows an embodiment, wherein the graphitic shells 212 are the only protection between the magnetic grains 210 and the environment. Since these layers 212 can be made very thin (each layer being a single atomic layer of graphene), the spacing between the magnetic grains 210 and the magnetic head 121 (FIG. 1) is extremely small. Since the strength of the magnetic field (either from the media or generated by the write head) decreases exponentially with distance, this reduced spacing greatly increases the performance of the magnetic recording system.

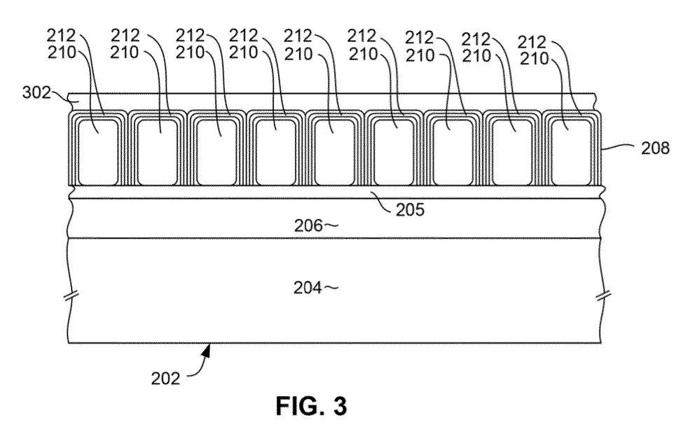

With reference now to FIG. 3, in another embodiment of the invention, an additional protective layer such as a carbon overcoat 302 can be provided over the onion like layers 212. This layer 302 can be amorphous diamond-like carbon or amorphous carbon. The layer 302 provides extra heat protection, good tribological properties, additional anti-corrosion protection and planarization. Although the layer 302 results in additional magnetic spacing as compared with the embodiment of FIG. 2, the presence of the onion-like graphitic layers 212 allows the layer 302 to be constructed much thinner than would be possible without the layers 212.

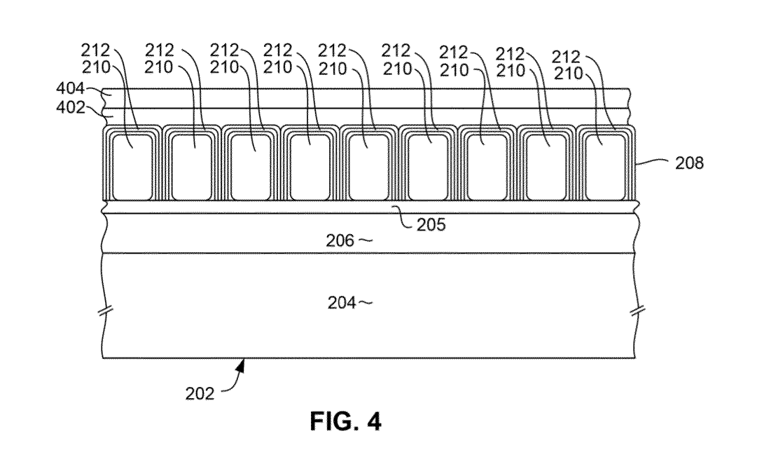

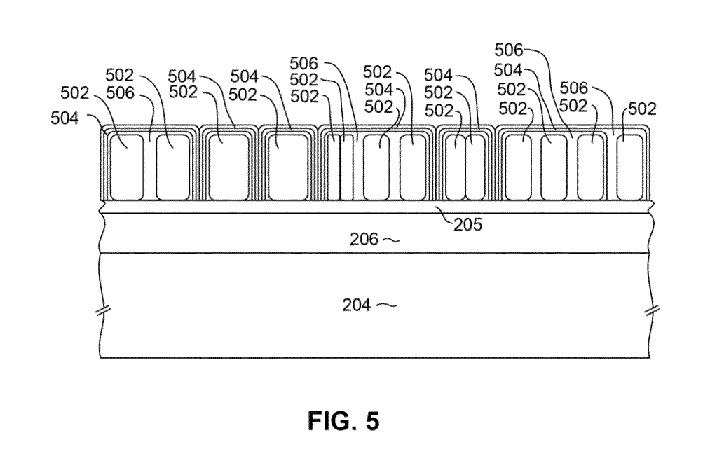

With reference to FIG. 4, in another embodiment, an addition two layers of protective coating 402, 404 can be provided. The first layer can be a carbon overcoat 402 such as amorphous diamond-like carbon or amorphous carbon, and the second layer 404 can be a material such as SiN, SiC, TiSiN, TiSiC, ZrN, ZrO₂ or ZrB₂. The first bottom layer 402 can provide additional anticorrosion protection and planarization. The upper layer 404 provides heat protection and good tribological properties.

Whereas, FIGS. 2-4 show an embodiment where each magnetic grain 210 is encased in onion like graphitic layers 212. In another embodiment of the invention, as shown in FIG. 5, multiple magnetic grains 502 can be encased within onions of graphitic carbon 504. In addition, these grains 502 can be separated from one another by non-magnetic segregant material 506, which could be an oxide, carbide or a nitride such as C, SiO₂, TiO₂, TaOₛ, SiC, SiN, TiC, TiN, BN, their mixture or some similar material.

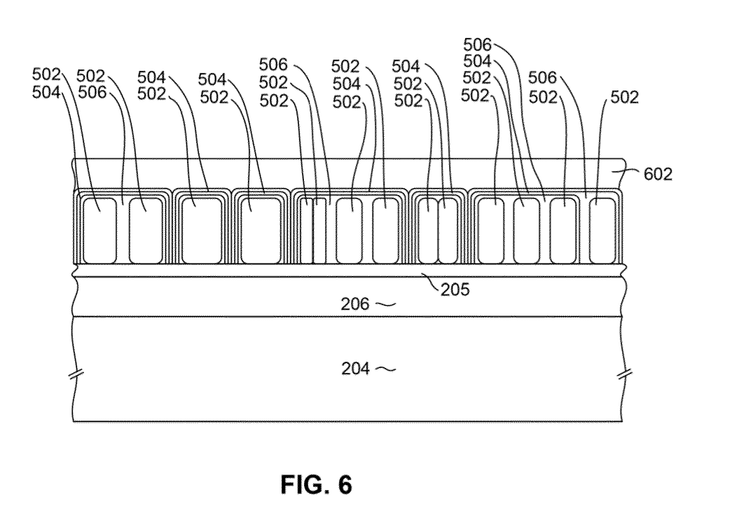

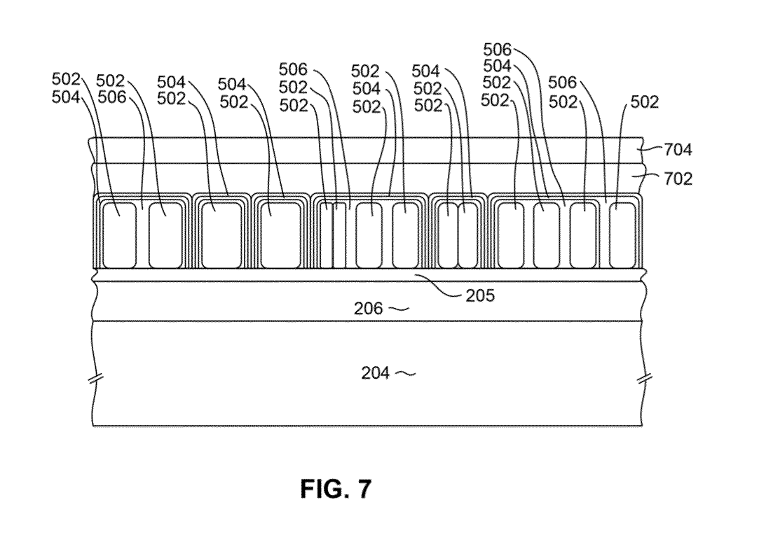

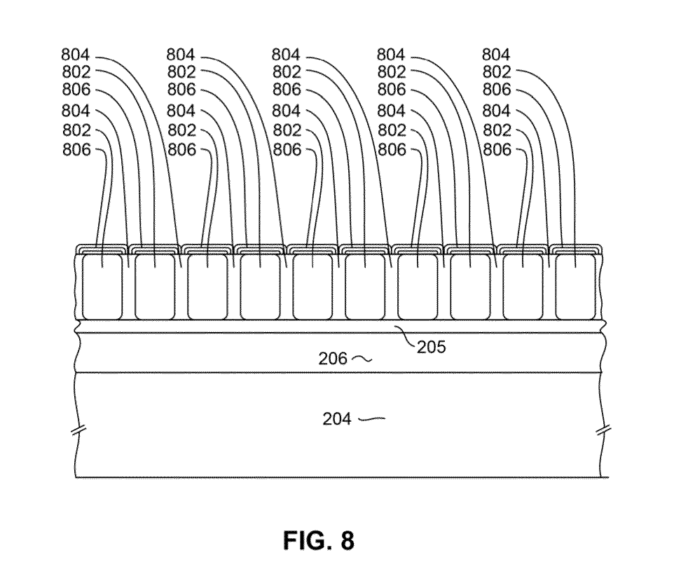

In addition, this multi-grain structure can be provided with an additional layer of protection such as a carbon overcoat 602 as shown in FIG. 6, or with two additional protective layers such as a carbon overcoat 702 and a protective layer 704 of SiN, SiC, TiSiN, TiSiC, ZrN, ZrO₂ or ZrB₂.

FIG. 8 shows yet another embodiment, wherein individual magnetic grains 802 are separated from one another by a non-magnetic segregant material 804. Layers of graphitic carbon 806 can be formed over the grains 802 as shown in FIG. 8. After forming the grains 802 and segregant 804, these layers 806 can be formed by subsequent deposition of carbon at high temperature on top of the grains 802, leading to the formation of graphene like carbon by catalytic effect. The additional layers of graphene like layers 806 planarize the surface and help to protect against corrosion.

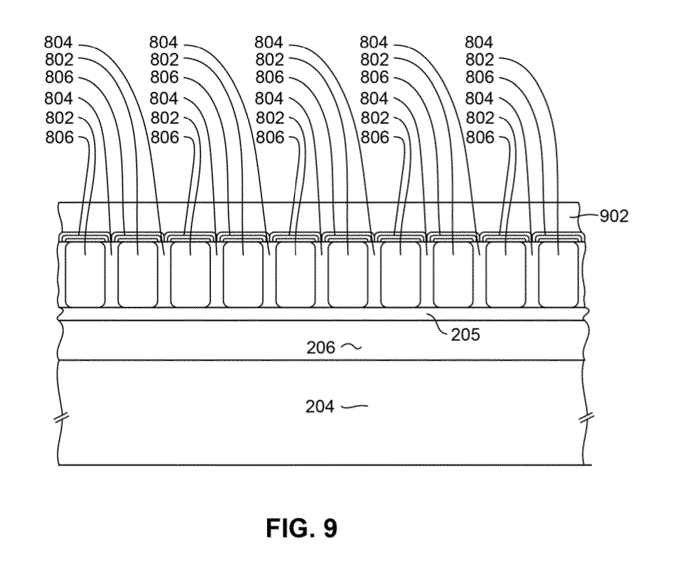

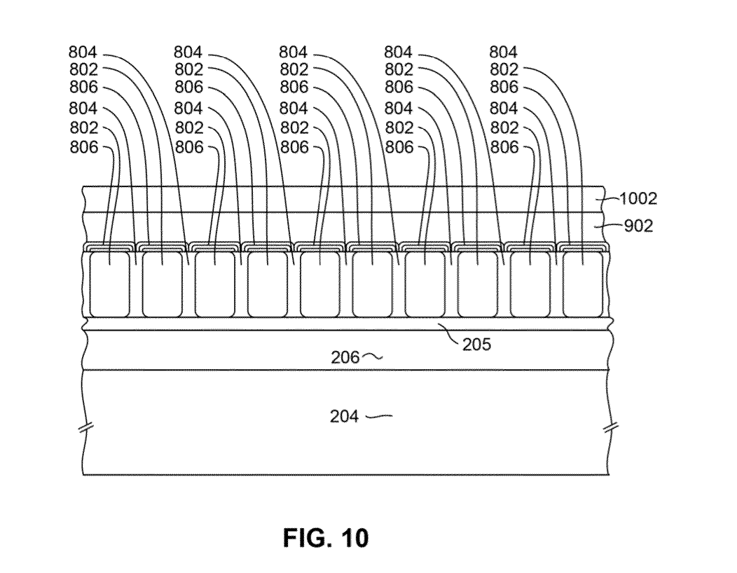

Optionally, a layer of carbon overcoat 902 can be applied to the structure of FIG. 8, leaving a structure as shown in FIG. 9. Also, a second protective layer 1002 such as SiNx, SiC, TisiN, ZrN, ZrOx, ZrB₂, etc. can be applied over the carbon overcoat 902, forming a structure as shown in FIG. 10.

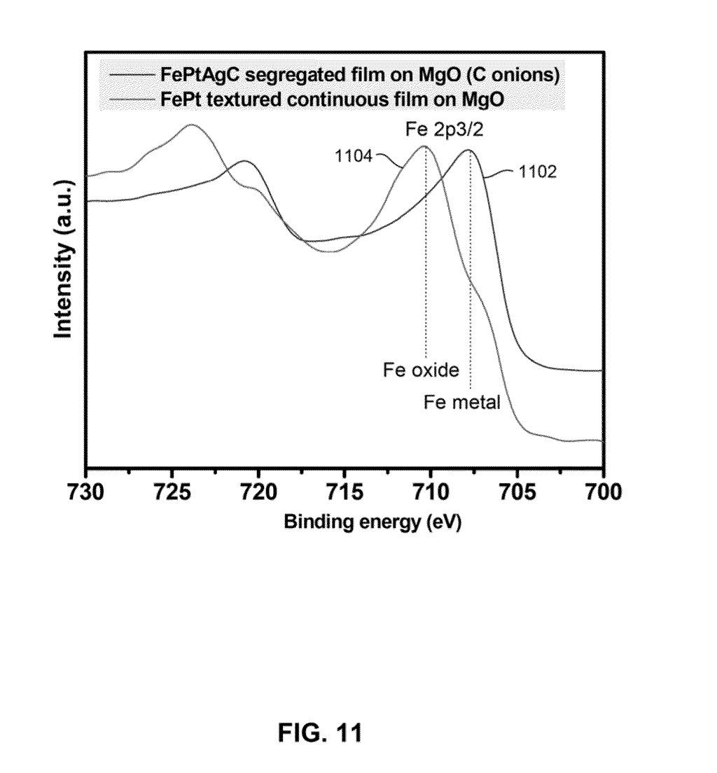

A magnetic media having magnetic grains covered by onion-like layers of graphitic carbon provides excellent protection against corrosion and wear. FIG. 11 shows the results of X-ray photoelectron spectroscopy (XPS) for a magnetic media having onion like graphitic protective layers as compared with a media having no such layers. In FIG. 11, line 1102 shows the results for a media having onion-like graphitic layers, whereas line 1104 shows the results for a media having no such layers. As can be seen, in the Fe 2p3/2 spectrum of a FePtAgC film having segregated grains encapsulated in carbon layers, Fe is present in its pristine metallic chemical state, whereas in the case of a FePt textured continuous film without the protective carbon layers Fe is partly oxidized with a native surface oxide.

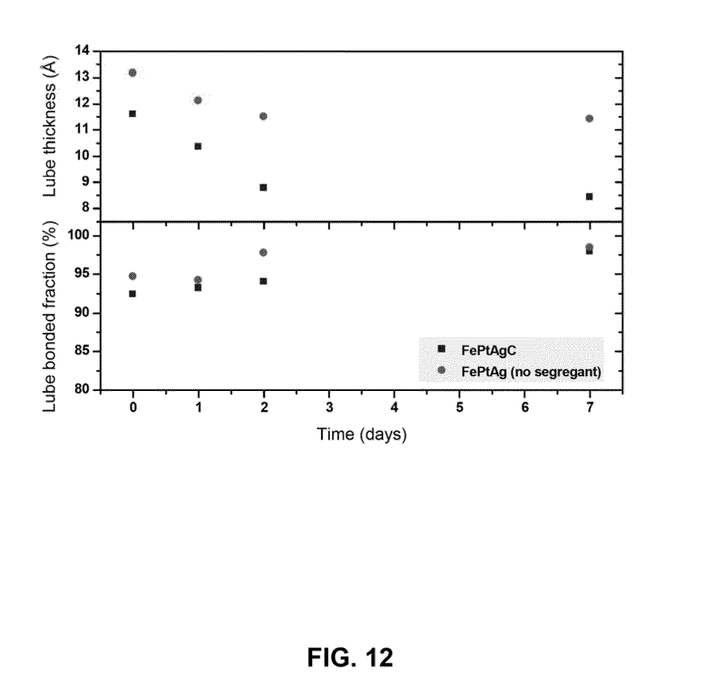

In addition, the onion like graphitic layers provide excellent compatibility with currently used lubricants, as is illustrated with reference to FIG. 12. In FIG. 12, the data points shown as squares in the graph represent data points for a media having the desired onion like graphitic layers, whereas the data points shown as circles represent data for a media having no such protective layers. FIG. 4 shows that a media having the graphitic layers is compatible with conventional lube (ZTMD) currently used in magnetic disk drives. All lubed disks exhibit relatively low surface energy, around 30 mN/m, which is comparable to current disk products. Low surface energy is a requirement to reduce contaminant attraction. Meanwhile, the surfaces of the disks are sufficiently reactive that the lubricant is effectively bonded. ZTMD adheres very well to all films with measured bonded fraction over 95% after one week.

While various embodiments have been described above, it should be understood that they have been presented by way of example only and not limitation. Other embodiments falling within the scope of the invention may also become apparent to those skilled in the art. Thus, the breadth and scope of the invention should not be limited by any of the above-described exemplary embodiments, but should be defined only in accordance with the following claims and their equivalents.

What is claimed is:

1. A magnetic media for magnetic data recording, comprising;
a plurality of magnetic grains;
a plurality of layers of graphitic carbon formed on each of the plurality of magnetic grains.

2. The magnetic media as in claim 1 wherein each of the plurality of layers of graphitic carbon is a single atomic layer of carbon.

3. The magnetic media as in claim 1 wherein each of the plurality of layers of graphitic carbon is a layer of graphene.

4. The magnetic media as in claim 1 wherein the layers of graphitic carbon are fullerenes.

5. The magnetic media as in claim 1 wherein the plurality of layers of graphitic carbon partially encases each of the plurality of magnetic grains.

6. The magnetic media as in claim 5 wherein the layers of graphitic carbon separate the magnetic grains from one another.

7. The magnetic media as in claim 1 wherein the magnetic grains are separated from one another by a non-magnetic segregant material.

8. The magnetic media as in claim 1 wherein at least some of the plurality of magnetic grains are jointly covered by a single set of graphitic layers.

9. The magnetic media as in claim 1 wherein the plurality of layers of graphitic carbon are the sole protective layers protecting the magnetic grains, there being no other protective layers formed thereover.

10. The magnetic media as in claim 1 further comprising a non-magnetic protective coating formed over the plurality of layers of graphene.

11. The magnetic media as in claim 1 further comprising first and second protective layers formed over the plurality of layers of graphitic carbon.

12. The magnetic media as in claim I further comprising a layer of diamond-like carbon or amorphous carbon formed over the plurality of layers of graphitic carbon.

13. The magnetic media as in claim 1 further comprising first and second layers formed over the plurality of grains of graphitic carbon, the first layer comprising diamond-like carbon or amorphous carbon, the second layer comprising, SiNx, SiC, TisiN, ZrN, ZrOx or ZrB₂.

14. The magnetic media as in claim 1 wherein the plurality of layers of graphitic carbon are formed one over the other like onion skins on an onion.

15. A magnetic data recording system, comprising:
a housing;
a magnetic media rotatably mounted within the housing;
an actuator; and
a magnetic head connected with the actuator for movement adjacent to a surface of the magnetic media;
the magnetic media further comprising:
a plurality of magnetic grains;
a plurality of layers of graphitic carbon formed on each of the plurality of magnetic grains.

16. The magnetic media as in claim 15 wherein each of the plurality of layers of graphitic carbon is a single atomic layer of carbon.

17. The magnetic media as in claim 15 wherein each of the plurality of layers of graphitic carbon is a layer of graphene.

18. The magnetic media as in claim 15 wherein each of the plurality of layers of graphitic carbon is a fullerene.

19. The magnetic media as in claim 15 wherein the plurality of layers of graphitic carbon partially encases each of the plurality of magnetic grains.

20. The magnetic media as in claim 15 wherein the magnetic grains are separated from one another by a non-magnetic segregant material.
